(19) United States
(12) Patent Application Publication
(10) Pub. No.: US 2007/0193381 A1
(43) Pub. Date: Aug. 23, 2007

(54) Screw actuator having means for blocking it in the event that it goes over to the secondary nut

(76) Inventor: Fernand Rodrigues, Figeac (FR)

Correspondence Address: BLAKELY SOKOLOFF TAYLOR & ZAFMAN, 1279 OAKMEAD PARKWAY, SUNNYVALE, CA, 94085-4040, US

(21) Appl. No.: 10/661,936

(22) Filed: Sep. 11, 2003

(30) Foreign Application Priority Data
Sep. 11, 2002 (FR) 0211229

(51) Int. Cl. F16H 1/20

(52) U.S. Cl. 74/89.26

(57) ABSTRACT

The invention relates to an actuator for actuating an aircraft member, said actuator essentially comprising a screw and at least two nuts including a primary nut and a secondary nut that are engaged on the screw, relative movement between the screw and the nuts generating said actuation, the secondary nut being disposed to take up the load on the screw in the event that the primary nut fails, the actuator further comprising a third nut, the secondary nut and the third nut having mutually overlapping portions and a breakable pin passing through said overlapping portions, the third nut being constrained to turn with the secondary nut by the pin so that, after the pin breaks, the third nut is free to turn relative to the secondary nut.

### FIELD OF THE INVENTION

The invention relates to “fail-safe” screw actuators, i.e. to actuators having a screw and two nuts. More particularly, the invention relates to systems for detecting load transfer from one nut to the other in such actuators.

For example, the invention is applicable to actuators, be they of the ball type, of the roller type, or of the wheel type, used for trimming a trimmable horizontal stabilizer (THS) of an aircraft.

### BACKGROUND OF THE INVENTION

Actuators are known that have additional safety levels constituted by the presence of a second nut which, being separated from the screw by a small amount of clearance, takes up the load on the primary nut in the event said primary nut fails.

While admittedly offering safety, such devices suffer from the risk that a mode of operation relying on the second nut only, after the first nut has failed, might not be detected. A device in such a situation no longer has its additional safety level, and therefore loses its initial advantage.

It is desirable to indicate that mode of operation as quickly as possible in order to avoid a dormant failure mode.

More precisely, it is desired for the secondary nut to be prevented from continuing to perform the movement-transmission function when said secondary nut is loaded in failure mode. Thus, it is desired for the secondary nut to be blocked, thereby ensuring that operating under dormant failure conditions cannot continue over time.

Typically, in that type of device, secondary nuts are adopted that are suitable for seizing when they cooperate with the screw.

However, it often happens that seizure does not occur. In-flight forces can be insufficient for the secondary nut to seize when it comes into contact with the screw.

### OBJECTS AND SUMMARY OF THE INVENTION

An object of the invention is to provide means for blocking after the forces go over to the secondary nut, which means are reliable while remaining inexpensive.

The invention achieves this object by means of an actuator for actuating an aircraft member, said actuator essentially comprising a screw and at least two nuts including a primary nut and a secondary nut that are engaged on the screw, relative movement between the screw and the nuts generating said actuation, the secondary nut being disposed to take up the load on the screw in the event that the primary nut fails, the actuator further comprising a third nut, the secondary nut and the third nut having mutually overlapping portions and a breakable pin passing through said overlapping portions, the third nut being constrained to turn with the secondary nut by the pin so that, after the pin breaks, the third nut is free to turn relative to the secondary nut.

### BRIEF DESCRIPTION OF THE DRAWINGS

Other objects, characteristics, and advantages of the invention appear on reading the following detailed description of the invention given with reference to the accompanying figures, in which:

FIG. 1 is a section view of an assembly comprising a primary nut, a secondary nut, and a lock nut of the invention;

FIG. 2 is an enlarged section view of a secondary nut and of a lock nut of the invention;

FIG. 3 is the same section view when the pin breaks; and

FIG. 4 is the same view, after the pin has broken, and after the secondary nut has been loaded.

### MORE DETAILED DESCRIPTION

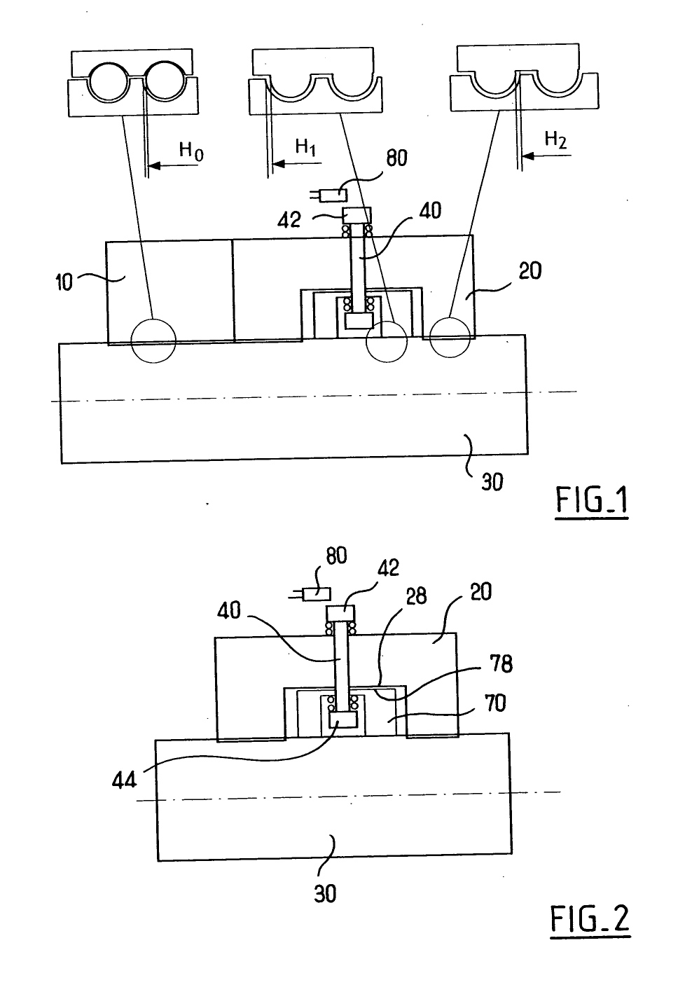

The pair of nuts 10 and 20 in FIG. 1 consist of a primary nut 10 and of a secondary nut 20 of a screw actuator whose structure is of the “fail safe” type.

Under normal operating conditions, the primary nut 10, which in this example is a ball nut, is loaded and transmits the load. In this example, the nut 10 transmits its movement to the trimmable horizontal stabilizer (THS) of an airplane, the screw 30 being coupled to the structure of the airplane.

Relative to the thread of the screw, the secondary nut 20 has clearance sufficient for it not to be loaded under normal operation conditions under which the primary nut 10 takes up the load.

In this example, the secondary nut 20 is thus merely a nut whose thread is a single-start male friction thread that is complementary to the thread 30. Naturally, a secondary ball nut could also be considered.

Fasteners between the two nuts 10 and 20 may be provided for providing relatively loose coupling between the two nuts.

The load goes over to the secondary nut by loading the coupling specific to the secondary nut, and by then unloading the coupling specific to the primary nut.

Typically, provision is made for each of the primary and secondary nuts 10, 20 to be coupled to the controlled element, which is the THS in this example, via a coupling that is specific to the nut.

The loose fasteners provided between the two nuts are stressed only when one of the two specific couplings of the nuts cannot transmit the load, e.g. due to accidental damage. Thus, if the coupling between the secondary nut and the THS cannot transmit the stresses, then the secondary nut, once loaded, transmits the stresses to the THS via the fasteners between the nuts, via the primary nut, and then via the specific coupling between the primary nut and the THS.

In this device, the secondary nut 20 is equipped with means for blocking said secondary nut after it has been loaded.

In FIG. 2, these means are constituted by a pin 40 which passes through the secondary nut 20 and through an additional nut referred to below as a “lock nut” and referenced 70.

It can be seen that the lock nut 70 is considerably smaller in size than the secondary nut 20, and it is placed in an annular internal groove in the secondary nut 20.

Thus, in the longitudinal section view of FIG. 2, the lock nut 70 is situated under the secondary nut 20, between two end walls 24 and 26 of said secondary nut 20.

Thus, in section, the secondary nut 20 straddles the lock nut 70 and flanks it between its legs 24 and 26. The secondary nut 20 thus forms a tube around the lock nut 70, which tube is closed over the thread of the screw at each end.

The above-mentioned pin 40 passes through both of the elements 20 and 70 at the same time. For this purpose, it passes through the tube-shaped wall of the nut 40, and then passes through the lock nut, until it comes into the vicinity of the thread of the screw.

The lock nut 70 itself has an internal groove, in which it receives an end head 44 of the pin 40, while the outer head 42 of the pin 40 emerges from the outside face of the secondary nut 20.

When the primary nut 10 has abnormal clearance relative to the screw, due to the coupling between the primary nut 10 and the screw 30 being damaged, the load is transmitted from the primary nut to the secondary nut 20, thereby reducing the clearance between the secondary nut 20 and the screw 30. This clearance is referenced H2 in FIG. 1.

It should be noted that the clearance H0 initially provided between the primary nut 10 and the screw 30 is smaller than the clearance H2, so that only particular damage to the coupling between the screw 30 and the primary nut 10 can cause the secondary nut to move into the clearance H2.

In addition, the lock nut 70 itself has clearance H1 relative to the screw.

The clearance H1 is chosen to be greater than the clearance H0 of the primary nut 10, but less than the clearance H2 of the secondary nut 20. Thus, since the clearance between the lock nut 70 and the screw 30 is less than the clearance between the secondary nut 20 and the screw, the secondary nut can be loaded only after the lock nut 70 has been loaded.

Such final loading of the secondary nut 20 on the screw 30 then unavoidably causes the pin 40 to shear.

The pin 40 breaking is used to allow the secondary nut 20 and the lock nut 70 then to turn relative to each other, the secondary nut and the lock nut coming into abutment against each other by turning through different amounts on the screw, thereby causing the actuator to be blocked completely by a two-nut clamping effect.

It should be noted that, in order to improve still further the establishment of abutting contact between the secondary nut 20 and the lock nut 70, the pin 40 is provided with a spring in the internal portion of the lock nut 70, which internal spring causes the head 44 of the pin 40 to be brought into abutment against the thread on the screw 30.

The head 44 then brakes the turning of the lock nut 70, while the turning of the secondary nut 20 is not braked.

The lock nut 70 even tends to turn with the screw under the effect of such braking. Thus, the nut 20 and the lock nut 70 come rapidly into abutment against each other.

It should be noted that, because the lock nut 70 is included in the secondary nut 20, i.e. flanked by two different faces of the nut 20, the lock nut and the secondary nut come into abutment regardless of the direction of rotation of the screw.

In preferred manner, care is taken to ensure that a coefficient of friction between the lock nut 70 and the nut 20 is particularly low at those of their faces which come into contact with each other, so that the lock nut 70 cannot start turning with the secondary nut 20 without generating the stresses necessary to block the system.

FIGS. 1, 3, and 4 show respective states of the various clearances H0, H1, H2 in respective ones of the above-described three successive states leading to blocking.

FIG. 1 shows such a system in its initial state, i.e. without any damage to the primary nut 10.

It can be observed that the clearance H1 of the lock nut 70 and the clearance H2 of the secondary nut 20 are sufficient to avoid putting either of the two elements in contact with the screw while the system is operating ordinarily.

In FIG. 3, it can be observed that wear appearing in the coupling between the screw 30 and the primary nut 10 causes the lock nut 70 to be brought into abutment against the screw 30, without the secondary nut 20 coming into abutment against the screw. In other words, the secondary nut driven by the primary nut pushes the lock nut 70 away against the screw without itself coming into contact therewith.

FIG. 3 also shows that, under the effect of this thrust, the pin 40 breaks and the secondary nut is free to engage the screw 30.

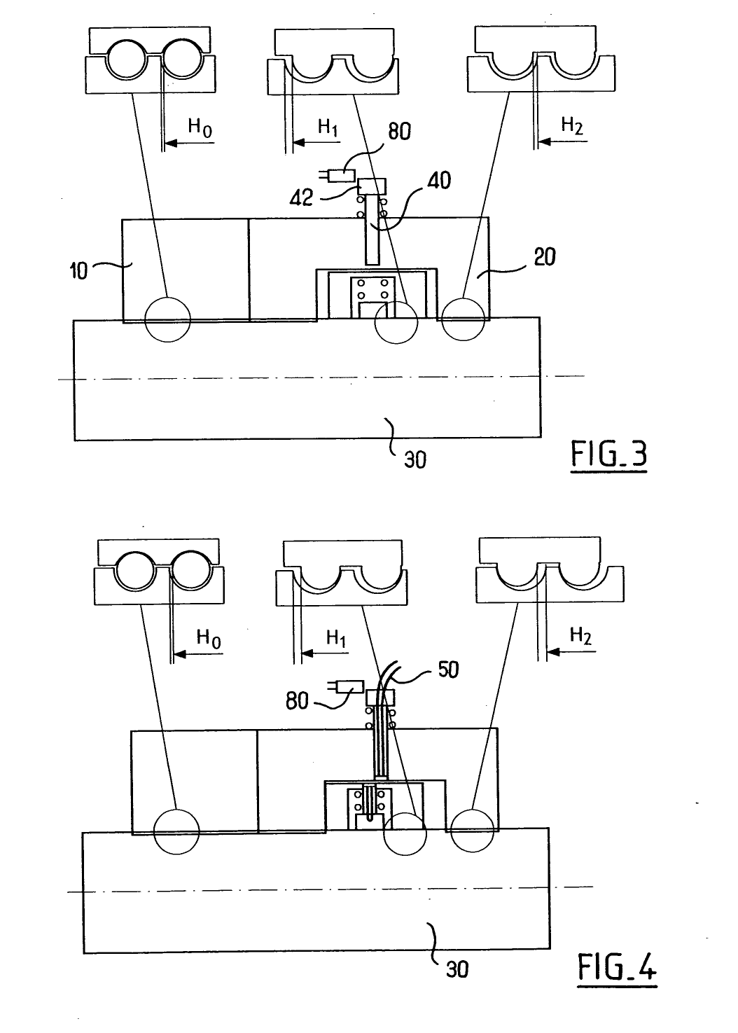

In FIG. 4, the secondary nut 20 has come into contact with the thread of the screw 30, and is transmitting the load from the THS to the screw. The lock nut 70 is then in abutment against an internal face of the secondary nut after having been driven by the screw. The lock nut 70 blocks the secondary nut on the screw. The clearances H1 and H2 are then taken up so that the respective threads of the lock nut 70 and of the secondary nut 20 are in engagement with the screw 30.

In order to confirm the failure by visual detection through examining the pin (by ejecting the portions separated by shearing), and in order to ensure that the two portions of the wire have been separated completely so as to prevent them from being reconnected by contact being re-established between them, a spring 60 may be interposed between one end of the pin 40 and a wall of one of the nuts, as shown in the figures.

Thus, as shown in FIG. 3, the pin 40 advantageously has a wider head 42 at one of its ends, a helical spring 60 bearing at one end against said wider head 42 and at its other end against the overlapping portion 22 that is part of the nut 20.

Advantageously, a conductor wire 50 is contained in the pin 40 which, for this purpose, is provided with a through hole, and an insulator surrounds the wire inside said hole.

By breaking, the pin 40 directly or indirectly causes a detector wire (not shown) that runs through it to undergo electrical interruption.

By breaking, after the pin 40 shears, the conductor wire 50 prevents the monitored electrical current from flowing, and thereby indicates the failure.

By breaking, the wire 50 also instructs electronic means to cause the actuator to be immobilized until the fault is repaired.

In this example, the wire 50 is also connected directly to a power supply system controlling the positioning of the actuator so that the actuator is caused to be immobilized in response to the wire breaking.

In addition, in this variant which is provided with a spring 60 for extending the pin after it breaks, the spring acts itself after shearing to generate a longitudinal tension necessary to break the wire 50.

More precisely in this example, the clearance between the secondary nut 20 and the lock nut 70 is sufficient to cause the pin 40 to break by shearing, but is insufficient to break the electrical wire 50 by shearing, said electrical wire 50 having a certain amount of shear resilience. Thus, after the pin breaks, the link 50 breaks only under the effect of a longitudinal extension force exerted by the spring 60.

It should be noted that the electrical wire 50 in this example is covered with a flexible insulating sheath which, in addition to imparting further shear flexibility to the wire 50, provides an insulation barrier between the wire and all of the metal portions of the system, thereby preventing any interference current from being generated before or after the breaking.

In a variant, the wire 50 is soldered at the two ends of the shear pin 40 to a very rigid portion guaranteeing electrical continuity for the wire 50 inside the pin. The very rigid portion makes it possible to guarantee that the electrical connection is broken cleanly in the event that the real displacement of the pin 40 is small.

It should be noted that these means for blocking the actuator after the secondary nut 20 has been loaded offer a definite advantage in themselves, independently of whether or not the pin has an electrical link running through it.

In an advantageous variant, a detector switch 80 is provided that is placed directly in the vicinity of the outer head 42 of the pin, and that is actuated by the head 42 when said head is pushed away towards the outside of the secondary nut 20 under drive from the external spring of the pin 40.

For example, the switch 80 may be a rocking arm having one end provided with a protuberance situated facing the secondary nut 20.

What is claimed is:

1. An actuator for actuating an aircraft member, said actuator essentially comprising a screw and at least two nuts including a primary nut and a secondary nut that are engaged on the screw, relative movement between the screw and the nuts generating said actuation, the secondary nut being disposed to take up the load on the screw in the event that the primary nut fails, the actuator further comprising a third nut, the secondary nut and the third nut having mutually overlapping portions, and a breakable pin passing through said overlapping portions, the third nut being constrained to turn with the secondary nut by the pin so that, after the pin breaks, the third nut is free to turn relative to the secondary nut, wherein the pin carries a head extending towards the screw, and a spring organized to push said head away against the screw when the pin breaks, so as to brake the turning of the third nut relative to the screw after the pin has broken.

2. An actuator according to claim 1, wherein clearances exist between the third nut and the screw, and between the secondary nut and the screw, the clearance of the third nut being smaller than the clearance of the secondary nut, so that moving the secondary nut in translation into its clearance causes the pin to break before mechanical co-operation takes place between the secondary nut and the thread of the screw.

3. An actuator according to claim 1, wherein the secondary nut and the third nut have respective facing faces that are transverse to the direction of the screw and that are organized to come into abutment with each other by moving relative to each other along the screw and then to prevent the secondary nut from turning relative to the screw.

4. An actuator according to claim 1, wherein the pin has an electrical link running through it so that the secondary nut moving relative to the third nut causes the pin to break by shearing and causes the electrical link to break.

5. An actuator according to claim 4, wherein clearance between the secondary nut and the third nut is chosen to cause the pin to break by shearing, without causing the electrical link to break by shearing, a spring being provided on the pin so as to push apart the portions separated by the shearing, and so as then to cause the link to break by having longitudinal traction applied to it.

6. An actuator according to claim 1, wherein the pin extends in a direction that is radial relative to the main axis of the screw.

7. An actuator according to claim 1, wherein the pin has two wider heads and is provided with two helical springs, each of which is placed between a wider head and an overlapping portion of a respective nut.

8. An actuator according to claim 1, wherein the electrical link extends over a go-and-return path inside the pin, the bend in which path is situated in the vicinity of that end of the pin which is closer to the screw.

9. An actuator according to claim 1, constituting an actuator of the ball type, roller type, or wheel type, i.e. in which a primary nut has a series of balls, rollers, or wheels on its face facing the screw for the purpose of providing moving contacts between the screw and the nut.
